(19) United States
(12) Patent Application Publication
(10) Pub. No.: US 2023/0299603 A1
(43) Pub. Date: Sep. 21, 2023

(54) SMART DUAL AC/DC POWER SYSTEM

(71) Applicant: Le Bread Xpress Inc., San Jose, CA (US)

(72) Inventors: Ronald Vinsant, Mountain View, CA (US); Benoit Herve, San Jose, CA (US)

(73) Assignee: Le Bread Xpress Inc., San Jose, CA (US)

(21) Appl. No.: 18/183,419

(22) Filed: Mar. 14, 2023

Related U.S. Application Data
(60) Provisional application No. 63/319,987, filed on Mar. 15, 2022.

(51) Int. Cl. H02J 7/00; H02J 7/02; H02M 1/42

(52) U.S. Cl. CPC H02J 7/00712; H02J 7/02; H02J 7/00036; H02J 7/0048; H02M 1/4208; H02J 7/0013; G06Q 30/0283

(57) ABSTRACT

A system and method are provided that use an AC power supply, a battery, and intelligent control, to power a system. During idle or down times, the power system stores energy from the AC power supply. When the powered system is in operation and the power needed exceeds that available from the AC power supply, stored power from the battery supplies the difference between the required power and the available AC power.

### CROSS-REFERENCE TO RELATED CASES

This application claims priority to U.S. Provisional Patent Application No. 63/319,987, entitled “Smart Dual AC/DC Power Architecture,” filed Mar. 15, 2022, which is hereby incorporated by reference.

### FIELD OF THE INVENTION

The present invention relates generally to the field of power systems and more particularly to secondary power systems used to supplement primary power sources.

### BACKGROUND

When using high-power equipment such as a vending machine, the power required may be more than that supplied by a standard power outlet. In North America, standard outlets are 120V and usually deliver up to 20 A maximum. Power is therefore limited to a maximum load at the specific outlet of 2400 W.

In order to install equipment with higher power requirements, and only 120V outlets are available, it then is typically necessary to change the cabling, receptacle, and circuit breaker to install a single or multiphase 208V or 240V receptacle. For example, automatic vending machines have systems that are used to dispense hot foods. These food dispensing systems are used to defrost, bake, brown, and serve through fully automated methods. Such systems typically require a large amount of electrical power, such as that supplied by electrical services of 200V to 240V, which increases installation costs.

Therefore what is needed is an apparatus that may supply power exceeding that available from the standard power supply.

### BRIEF DESCRIPTION OF THE DRAWINGS

The embodiments are illustrated by way of example and not limitation in the accompanying drawings, in which like references indicate similar elements, and in which:

FIG. 1 is an illustration of an embodiment of a smart dual ac/dc power system;

FIG. 2 is a schematic diagram of an embodiment of a smart dual ac/dc power system;

FIG. 3 is a schematic diagram of an embodiment of a smart dual ac/dc power system;

FIG. 4 is a schematic diagram of aspects of an embodiment of a smart dual ac/dc power system;

FIG. 5 is a schematic diagram of aspects of an embodiment of a smart dual ac/dc power system;

FIG. 6A is a chart illustrating considerations and benefits of the use of an embodiment of a smart dual ac/dc power system;

FIG. 6B is a chart illustrating considerations and benefits of the use of an embodiment of a smart dual ac/dc power system;

FIG. 7 illustrates the steps of a method employing an embodiment of a smart dual ac/dc power system;

FIG. 8 shows a simplified block diagram of an embodiment of a distributed computer system supporting smart power system; and

FIG. 9 shows a diagram of an example of a computing device from an embodiment of a smart power system.

### DETAILED DESCRIPTION

The description within describes using a battery, in addition to a standard AC power supply and combined with intelligent control, that will store energy during the off or idle time of the machine and use power from both the battery and standard AC power supply during operation. When the equipment is in operation and the power needed exceeds that which the standard 120V outlet can supply, an intelligent system will add additional power from the battery to make up the difference between 120V available power and required machine power.

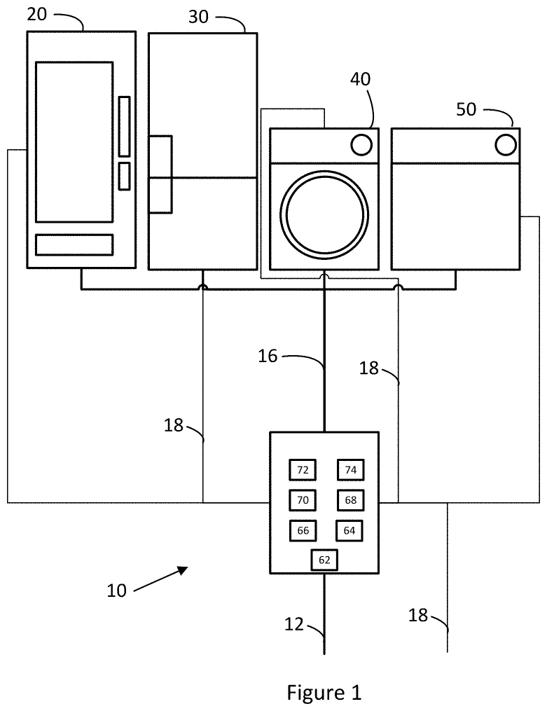

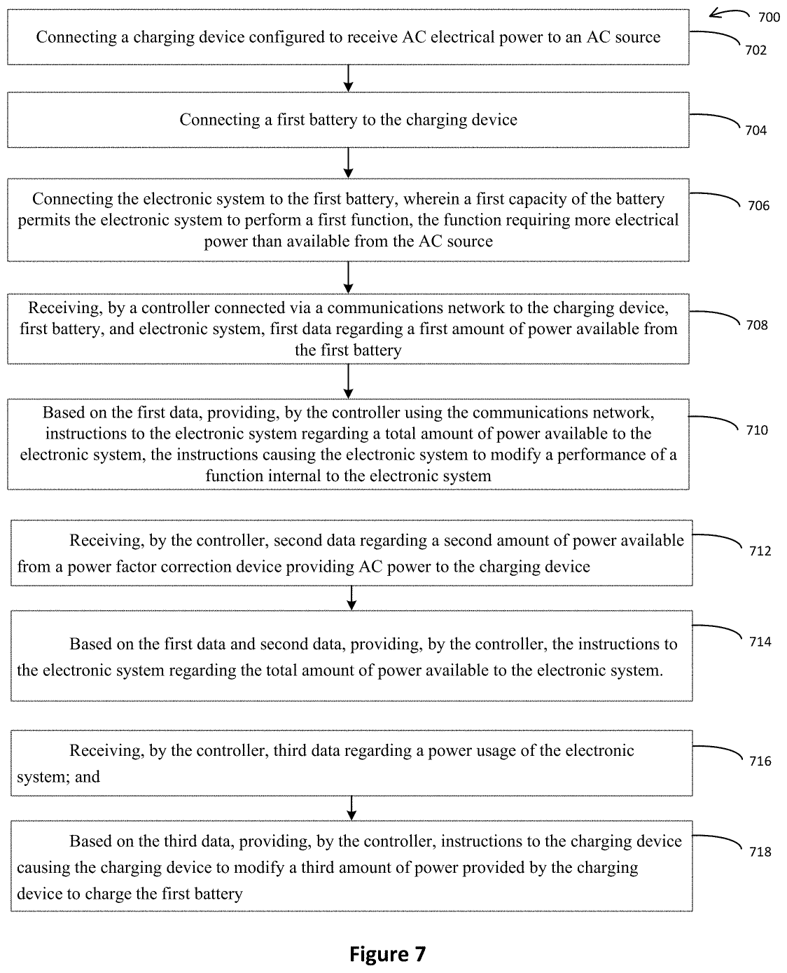

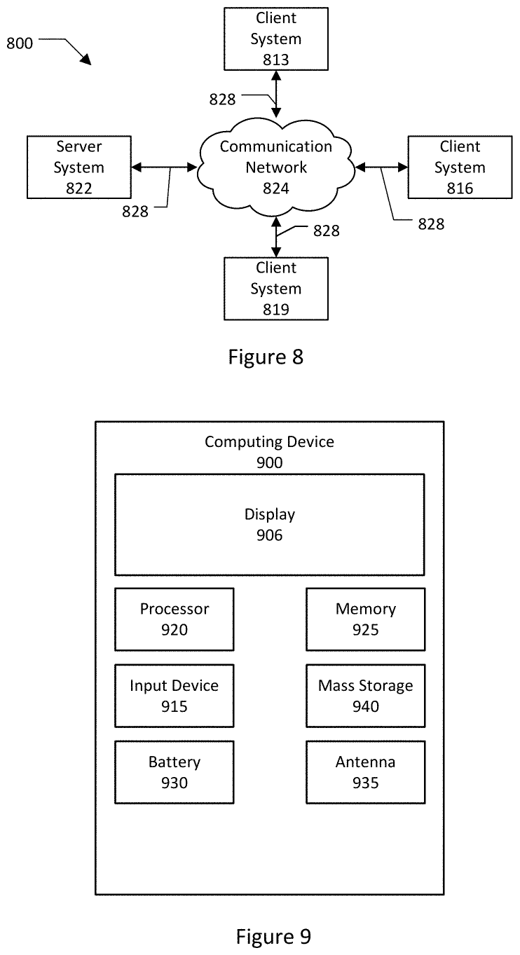

FIG. 1 illustrates an embodiment of a smart power system 10. In FIG. 1, power system 10 may include one or more chargers 62, one or more batteries 64, a network interface 66 providing access to a network 18, and a controller 70. In operation, a charger 62 receives power from a source 12 to a charge battery 64. Power 16 from power system 10 may be supplied to one or more systems, e.g., a vending machine 20, a refrigerator 30, a clothes dryer 40, or an oven 50. System 10 may include a converter 68 to convert DC power from battery 64 to DC power of a different voltage for systems 20, 30, 40, 50. Similarly, system 10 may include an inverter 72 to convert DC power from battery 64 to AC power for systems 20, 30, 40, 50, and/or a converter 74 to convert DC power from battery 64 to a different voltage for any system being powered. Controller 70 may receive data from power source 12 and an attached system 20, 30, 40, 50 via network interface 66 and, based on available source power and system power requirements, control the operation of the overall system, e.g., by controlling the charging of battery 64 and controlling the operation of a connected system 20, 30, 40, 50. Network interface 66 may represent a communications network allowing communications between each of elements 62 . . . 72 and between controller 70 and network 18, as described with further reference to FIG. 8 and FIG. 9.

Thus, in an embodiment, when power source 12 is an insufficient power supply, power system 10 may be used augment power source 12 with power from battery 64 to supply a connected system with sufficient power. In addition, in an embodiment, when the price of electricity from power source 12 is relatively lower, power system 10 may be used store power from power source 12 and supply that stored power to a connected system when the price of electricity from power source 12 is relatively higher.

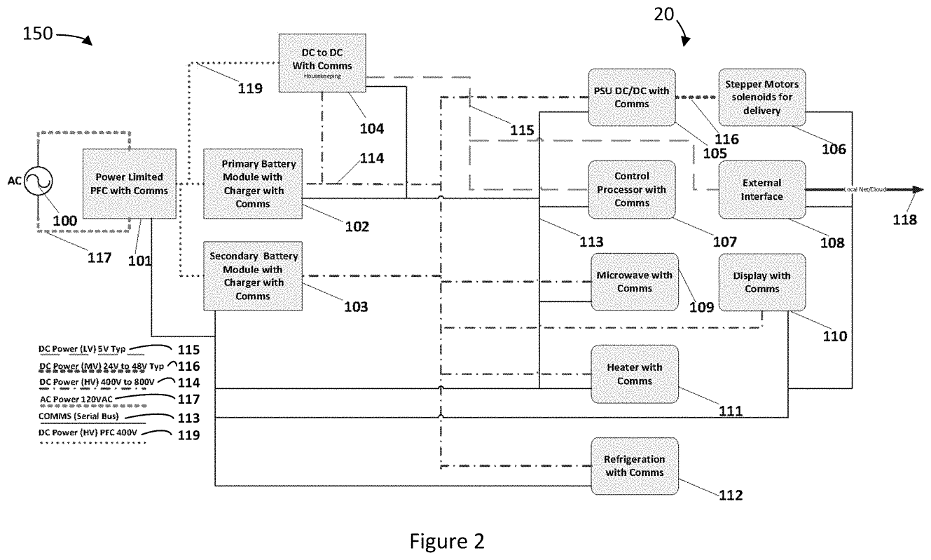

FIG. 2 illustrates an embodiment 150 of a smart dual AC/DC power system 10 powering an exemplary device—vending machine 20. In this embodiment, vending machine 20 is DC powered. In FIG. 1, AC/DC power system 150 includes a primary battery module 102 with charger and a communication interface (“comms”—an interface module that provides a connection to a comms network 113, e.g., a serial bus), a controller 107 with comms, an optional PFC (Power Factor Corrector) 101, an optional secondary battery module 103 with comms, an optional DC to DC converter 104 with comms, and an optional external network interface 108 to an external network 118. Vending machine 20 includes a microwave 109 with comms, a heater 111 with comms, a refrigeration unit 112 with comms, a display 110 with comms, a PSU DC/DC 105 with comms, and stepper motor solenoids 106 with comms, which are used for product delivery.

AC source 100, e.g., a wall receptacle with a supply voltage of 120V, via a power cord 117, feeds PFC (Power Factor Corrector) 101, which may be used to maximize the available power from the AC source 100 and to maximize the total available power from that source. A benefit of PFC 101 is that it allows power to be drawn from AC source 100 over the entire line cycle, thus allowing the total amount of power from the AC to be converted to pulsating DC. An additional benefit of PFC 101 is that a PFC provides power system 150 with the ability to be powered from any source, e.g., from 100 VAC to 260 VAC. Controller 107, via comms network 113, may ascertain the amount of power available from PFC 101 or AC source 100, and thus determine the amount of power that vending machine 20 may utilize in order to manage the power distribution within the machine. Output 119 of PFC 101 is fed to primary battery module 102 that has an integral charger which may be controlled by controller 107 through comms network 113 to regulate the amount of energy used to charge primary battery 102 and secondary battery 103, after controller 107 has determined power needs of the system being powered, e.g., vending machine 20. In some embodiments, it is envisioned that only one battery, primary 102, might be used. PFC output 119 also feds DC to DC “housekeeping converter” 104. Output 115 of DC to DC “housekeeping converter” may be used to power controller 107 and external network interface 108.

In an embodiment, when AC source 100 is activated from a zero power condition DC to DC “housekeeping converter” 104, controller 107 and external network interface 108 are powered up first. In this embodiment, controller 107 will determine the sequence that vending machine 20 will activate each of the system elements, which will depend on, e.g., the type of product to be vended, the available power, and the cost of power at the time of activation. The cost of power and the type of product in the vending machine may be determined by controller 107 by communication with vending management and the local utility through external network interface 108. Controller 107 may also communicate through comms network 113 to diagnose operation of any of power system 150 and vending machine 20 elements including but not limited to the DC to DC “housekeeping converter” 104 and external network interface 108.

Primary battery module 102, whose output is a DC bus 114, powers PSU DC/DC with comms 105, microwave with comms 109, heater with comms 111, refrigeration with comms 112, and display with comms 110, and functions as backup power for DC to DC “housekeeping converter” 104. This allows power system 150 to continue to operate and communicate via external network interface 108 through network 118 in the event of an AC mains failure. In an embodiment, PSU DC/DC 105 with comms may be combined with DC to DC 104 with comms in one unit. Where PSU DC/DC 105 with comms powers mechanical aspects of the machine being powered, DC to DC 104 with comms powers the electronics. It is therefore likely that, in the event of a failure in the mechanical section of the machine being powered, the combined unit may have to go into a protective mode and shutdown. This may also shut down the electronics of power system 150, with the result that power system 150 would not be able to communicate that it there has been a failure to the outside world.

A DC bus 115, e.g., 5V to 24V DC bus, may be used as an “always on” power source for the controller 107 and external network interface 108. This allows access, e.g., by an administrator, through network 118 to manage vending machine 20 at any time.

Microwave 109 with comms is supplied DC power through DC bus 114. Controller 107 may control a cooking power level of microwave 109 and provide diagnostic abilities through comms network 113. Diagnostic information regarding microwave 109 may be used to offset aging issues in microwave power output through temperature measurement and carousel motor wear by measuring input power to the motor thus minimizing down time due to maintenance.

Heater 111 with comms is fed DC power through DC bus 114. Controller 107 may control a cooking power level of heater 111 and provide diagnostic abilities through comms network interface 113. Diagnostic information may be used to offset aging issues in infrared power output through temperature measurement and by measuring input power to the emitters thus minimizing down time due to maintenance.

Refrigeration 112 with comms 112 is fed DC power through DC bus 114. Controller 107 communicates through comms network interface 113 to a VFD (variable speed drive, not shown) that is used to power the compressor to set the amount of time vs. temperature of the refrigeration, thus minimizing the power use depending on the amount of product in the vending machine. In addition, the current used by the VFD as well as temperature may be measured and communicated back to controller 107 through comms network interface 113.

Display with Comms 110 is fed DC power through DC bus 114. Controller 107 communicates through comms network interface 113 to determine and to display the products that are available in the vending machine. In the event of a failure of vending machine 20, the display may warn the customer not to use the machine and this information may be sent to an administrator, e.g., machine management, via external network interface 108 and network 118.

PSU DC/DC 105 with comms is fed DC power through DC bus 114. Output 116 of PSU DC/DC 105 with comms is used to power stepper motor solenoids 106 that mechanically direct product from the cooking process to the customer. Measuring currents, voltages, and temperatures of these elements, and then communicating these parameters via comms network interface 113 to the controller 107, provides data that controller 107 may analyze diagnose.

Controller 107 is used to manage power so that the combination of the available input power from the PFC 101 combined with power from primary battery module 102 provides enough power for vending machine 20 to operate where that operation requires power levels above that available from AC mains 100. During idle periods or periods of low power operation, primary battery module 102 with charger and comms, as well as secondary battery module 103, may recharge from PFC 101.

In the embodiment, power available to vending machine 20 is the sum of the stored power of primary battery module 102 and, if so equipped, secondary battery module 103, in additional to power available from PFC 101 being conducted through the battery modules 102, 103. Thus, the capacities of primary battery module 102 and, if so equipped, secondary battery module 103, are sized based on power requirements of vending machine 20, e.g., the power draws and the durations that the power draws are predicted or determined to exceed the power available from source 100. In other words, the size of the primary battery module 102 is dependent on the usage model of the machine being powered, e.g., vending machine 20. The usage model is unique to each application thus one or more battery modules 102, 103 could be used.

In some embodiments, a sufficiently sized primary battery 102 with power management may allow a machine being powered, e.g., vending machine 20, to operate with a reduced draw on source 100, which allows system 150 to take advantage of time of day power pricing. Thus, power system 150 may be used even where source 100 supplies sufficient power, e.g., power sufficient for vending machine 20, to draw and store power from source 100 when prices are low, for subsequent use by vending machine 20 at times when prices are relatively higher. In such uses, controller 107 controls the chargers associated with primary and secondary batteries to reduce or eliminate the drawing of power from source 100 when prices are higher, as determined by controller 107 from data received by the electricity supplier.

Controller 107 may have diagnostic failure levels set so that predictive maintenance may be achieved. These failure and/or warning levels may be both sent out to machine management and received from machine management via external network interface 108 and network 118. In addition, such failure and/or warning levels may be adjusted via external network interface 108 over time as machine management learns issues from the installed population of machines, e.g., vending machines 20.

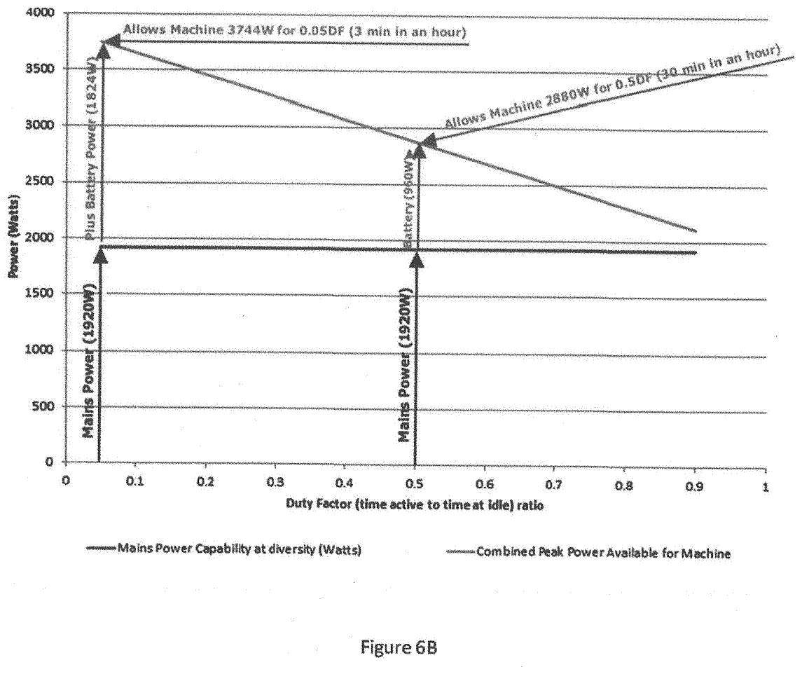

In embodiments, functions discussed as being performed by controller 107 may be performed by one or more computing devices connected via network 118, e.g., as discussed with reference to FIG. 7 and FIG. 8.

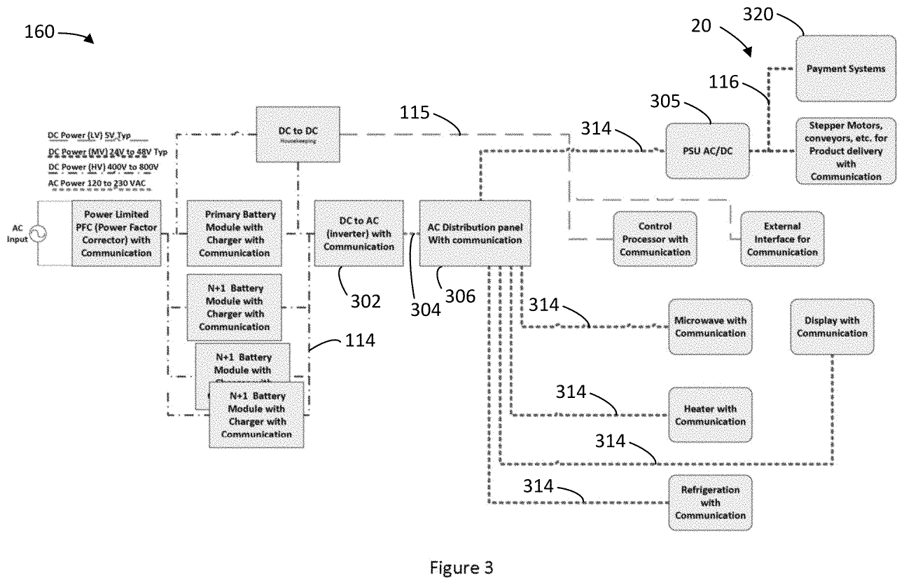

FIG. 3 illustrates an embodiment 160 of a smart dual AC/DC power system 10 powering an exemplary device—vending machine 20. In this embodiment, vending machine 20 is AC powered. Power system 160 is substantially similar to power system 150 (FIG. 2) and the description of FIG. 3 will be directed to the differences between the embodiments. Power system 160 should therefore be understood to have the elements and capabilities of power system 150 except where this description differs from that of power system 150.

FIG. 3 illustrates an embodiment that distributes AC power. In this embodiment, power system 160 includes a DC to AC inverter 302 with comms that connects to DC output 114 from primary battery module 102 and any secondary battery module 103 (shown as “N+1 Battery Module” in FIG. 3). DC to AC inverter 302 provide AC output 304 to an AC distribution panel 306 with comms, which distributes AC power 314 to the systems of vending machine 20. In this embodiment, vending machine 20 is provided with a PSU AC/DC inverter 305, that provides DC power 116 to a payment system 320 and stepper motor solenoids.

In embodiments, AC source 100 may be different from 100 to 120 VAC previously discussed. For example, AC source 100 may range up to 230 VAC or 400 VAC without departing from the teachings of this disclosure. Such higher input voltages may be used advantageously by embodiments to reduce the requirements elsewhere in the system. For example, higher input voltages of 230 VAC or 400 VAC may be used to lower the peak power requirements of the system so that, e.g., instead of a 30 A circuit being required, a 20 A circuit may be sufficient.

In embodiments, the capacity of primary battery 102 and any secondary batteries 103 may be adjusted depending on the usage model of the system to be powered. Each different system 20, 30, 40, 50 may have a different usage model, referred to within as a duty factor (df). Primary battery module 102 and any secondary battery modules 103 may be initially specified based on an initial model. Data received by controller 107 from the machine being power regarding its usage and data regarding source power 100 and primary battery module 102 power supply and the power supply from any second battery modules 103 may be analyzed (e.g., by controller 107, or a networked system) to determine whether more battery capacity (or less) is warranted by the system being powered. The analysis may also be affected by the electricity time of day pricing. In other words, it may be determined that a larger battery capacity would enable the system to function more cost-effectively by storing more power when rates are lowest. As a result of the analysis, controller 107, or the system performing the analysis, may recommend a change to the battery capacity of the system. For example, the recommendation may be that a larger primary battery module 102 be swapped in, that a secondary battery module 103 be added. In some circumstances, it may be that the recommendation is that a smaller primary battery module 102 would be sufficient, or that a secondary battery module 103 may be removed. In embodiments, the recommendation may be initiated by controller 107, or the system performing the analysis, and delivered to a system administrator or other operator. In embodiments, controller 107 or the system performing the analysis may analyze system data using AI.

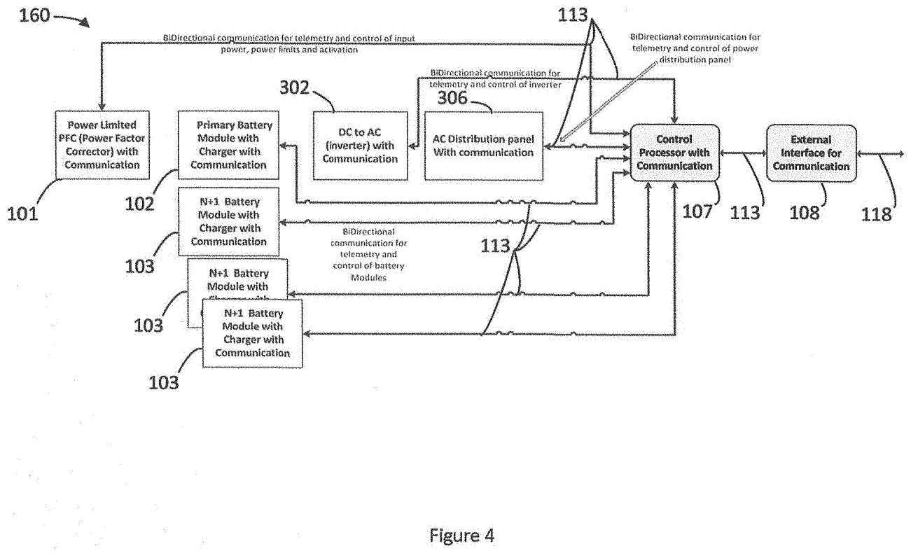

FIG. 4 illustrates aspects of comms network 113 that may be employed by embodiments 10, 150, 160. These aspects will be discussed with regard to embodiment 160. In embodiments, controller 107 may communicate with elements of the system, including external interface 108, through comms network 113. The communications may be bi-directional, e.g., such that data and commands may be sent and received by any system on comms network 113. For example, communication between PFC 101 and controller 107 may including bidirectional communications for telemetry and control of input power, power limits, and activation; communication between DC to AC inverter 302 and controller 107 may include bidirectional communications for telemetry and control of inverter 302; communications between AC distribution panel 306 and controller 107 may include bidirectional communications for telemetry and control of power distribution panel 306; and communications between primary battery module 102 and any secondary battery module 103 may include bidirectional communications for telemetry and control of the battery modules 102, 103. External network interface 108 then allows communications with power system 160 and the system being powered, including, e.g., monitoring the system elements, programming the system elements, and controlling the system elements.

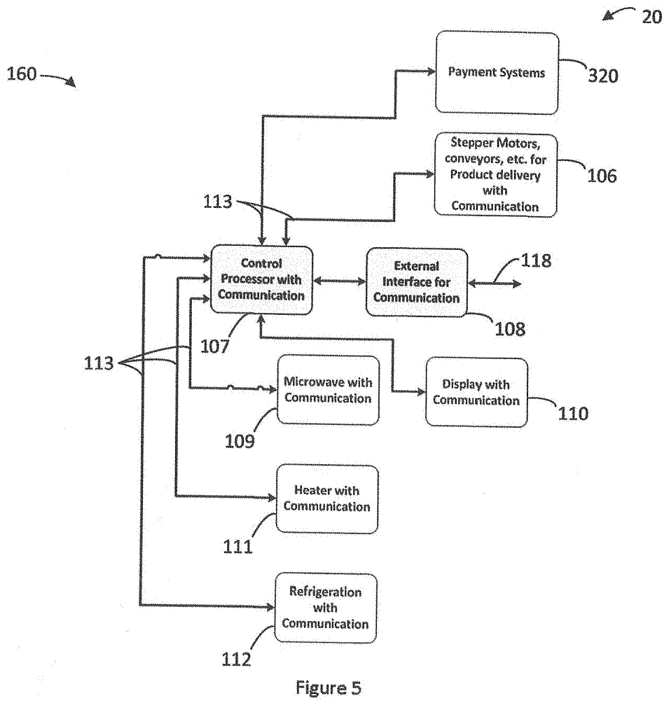

FIG. 5 illustrates aspects of comms network 113 that may be employed by embodiments 10, 150, 160 to communicate with and control the system being powered, e.g., exemplary vending machine 20 and its subsystems. In embodiments, controller 107 may communicate with elements of the system being powered through comms network 113. The communications may be bi-directional (depending on the capabilities of the system being powered), such that data and commands may be sent and received by any subsystem of vending machine 20 on comms network 113. External network interface 108 then allows communications with power system 160 and the subsystems of the system being powered.

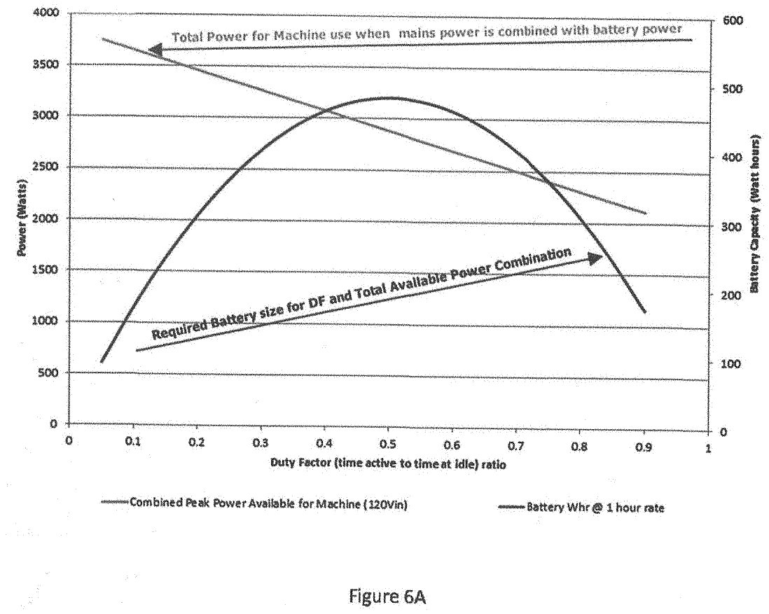

FIG. 6A is a chart illustrating considerations and benefits regarding the use of an embodiment of a smart dual ac/dc power system 10. The chart of FIG. 6A is based on the data of Table 1.

TABLE 1

| | | | | | | Max | | Combined | |
|---|---|---|---|---|---|---|---|---|---|
| Battery | Load | | Line | Current | Mains | Battery | | Peak | |
| charge | active | | Voltage | capability | Power | Power to | | power | |
| time in | time in | | (Volts | Max | Capability | assure | Power | Available | Battery |
| 60 min | 60 min | | AC | (Amps | at diversity | recharge | Improvement | for | Whr@ 1 |
| period | period | df | RMS) | AC RMS) | (Watts) | (Watts) | ratio | Machine | hour rate |
| 57 | 3 | 0.05 | 120 | 20 | 1920 | 1824 | 1.95 | 3744 | 91 |
| 54 | 6 | 0.1 | 120 | 20 | 1920 | 1728 | 1.9 | 3648 | 173 |
| 51 | 9 | 0.15 | 120 | 20 | 1920 | 1632 | 1.85 | 3552 | 245 |
| 48 | 12 | 0.2 | 120 | 20 | 1920 | 1536 | 1.8 | 3456 | 307 |
| 45 | 15 | 0.25 | 120 | 20 | 1920 | 1440 | 1.75 | 3360 | 360 |
| 42 | 18 | 0.3 | 120 | 20 | 1920 | 1344 | 1.7 | 3264 | 403 |
| 39 | 21 | 0.35 | 120 | 20 | 1920 | 1248 | 1.65 | 3168 | 437 |
| 36 | 24 | 0.4 | 120 | 20 | 1920 | 1152 | 1.6 | 3072 | 461 |
| 33 | 27 | 0.45 | 120 | 20 | 1920 | 1056 | 1.55 | 2976 | 475 |
| 30 | 30 | 0.5 | 120 | 20 | 1920 | 960 | 1.5 | 2880 | 480 |
| 27 | 33 | 0.55 | 120 | 20 | 1920 | 864 | 1.45 | 2784 | 475 |
| 24 | 36 | 0.6 | 120 | 20 | 1920 | 768 | 1.4 | 2688 | 461 |
| 21 | 39 | 0.65 | 120 | 20 | 1920 | 672 | 1.35 | 2592 | 437 |
| 18 | 42 | 0.7 | 120 | 20 | 1920 | 576 | 1.3 | 2496 | 403 |
| 15 | 45 | 0.75 | 120 | 20 | 1920 | 480 | 1.25 | 2400 | 360 |
| 12 | 48 | 0.8 | 120 | 20 | 1920 | 384 | 1.2 | 2304 | 307 |
| 9 | 51 | 0.85 | 120 | 20 | 1920 | 288 | 1.15 | 2208 | 245 |
| 6 | 54 | 0.9 | 120 | 20 | 1920 | 192 | 1.1 | 2112 | 173 |

FIG. 6B is a chart illustrating considerations and benefits regarding the use of an embodiment of a smart dual ac/dc power system 10. In FIG. 6B, power from 120 VAC input power (e.g., AC input 100) is added to power from the battery (e.g., primary battery module 102) to allow higher peak powers during machine operation (e.g., of vending machine 20). During idle or low power operation the battery may recharge from the input power. Power available to the machine is based on the duration that peak power usage occurs and battery size. These calculations do not include power conversion efficiency and are idealized.

FIG. 7 illustrates the steps of a method 700 employing an embodiment of a smart dual ac/dc power system to provide power to an electronic system. Method 700 includes steps 702-706. Step 702 requires connecting a charging device configured to receive AC electrical power to an AC source. Step 704 requires connecting a first battery to the charging device. And step 706 requires connecting the electronic system to the first battery, wherein a first capacity of the battery permits the electronic system to perform a first function, the function requiring more electrical power than available from the AC source.

In addition, method 700 may include steps 702-710. Step 708 requires receiving, by a controller connected via a communications network to the charging device, first battery, and electronic system, first data regarding a first amount of power available from the first battery. And step 710 requires, based on the first data, providing, by the controller using the communications network, instructions to the electronic system regarding a total amount of power available to the electronic system, the instructions causing the electronic system to modify a performance of a function internal to the electronic system.

In addition, method 700 may include steps 702-714. Step 712 requires receiving, by the controller, second data regarding a second amount of power available from a power factor correction device providing AC power to the charging device. And step 714 requires, based on the first data and second data, providing, by the controller, the instructions to the electronic system regarding the total amount of power available to the electronic system.

In addition, method 700 may include steps 702-710 and 716 and 718. Step 716 require receiving, by the controller, third data regarding a power usage of the electronic system. And step 718 requires, based on the third data, providing, by the controller, instructions to the charging device causing the charging device to modify a third amount of power provided by the charging device to charge the first battery.

### Technical Overview

In embodiments, a machine being powered, e.g., vending machine 20, is utilizing AC distribution, e.g., source 12. In embodiments, as illustrated in FIGS. 1-7, a battery(s), or other energy storage devices, e.g., battery 64, adds peak power capability to the power-limited source, e.g., a 120V input. This additional energy stored in the battery, adds power capability to the 120VAC input allowing the connected machine to function at a higher power level that the power source. During idle or non-operational times, the battery may be recharged. The size of the battery is dependent on the machine usage model. The usage model is unique to each application (referred to as duty factor or df). One or more battery modules could be used. An AI algorithm in the control processor, e.g., controller 107, may determine the need for additional battery modules. The capability to run the AI algorithm could be augmented by transferring both tasks and data through the external interface, e.g., external network interface 108, to a cloud server. A large enough battery(s) with proper power management by the control processor would allow the machine to operate with significantly reduced input power to take advantage of the time of day power pricing.

The following paragraphs include further description of the various subsystems.

“With communication,” e.g., as seen in PFC 101 “with comms,” refers to the ability to transmit and receive data related to the specific function through digital or analog means—comms network 113. The data may be used for telemetry, monitoring the function's operation, and controlling the process, e.g., to activate a motor or heater.

AC input 100. In embodiments, the main source of power may be, typically, a 100 to 120 VAC main. Another source may be a 230 to 400V input. Higher input voltages could be used to lower the peak power requirement in a 230 to 400V installation, e.g., instead of a 30 A circuit being required, a 20 A source would be sufficient.

PFC 101. In an embodiment, a power factor corrector or “PFC” may be utilized to optimize the main's energy use and control the amount of power supplied from the AC input. comms network 113 may be used to transfer data about the PFC's critical operating parameters such as total available output power, operating temperature, and input voltage. A control processor, e.g., controller 107, local to the PFC may be used for all internal control functions and may be reprogrammable through external network interface comms network 113 from an external computing device. Modifications to the PFC firmware may be accomplished through the remote communications port via the control processor.

DC to DC 104 with comms (“housekeeping”). In an embodiment, a housekeeping power supply may be used to bias the electronics used in the system. A DC (from the PFC, Primary Battery Module, or Secondary Module) to DC (typically 12V) may be utilized to supply downstream regulators in the system. Communications capability may or may not be used depending on the application.

Primary battery module 102 with charger and communication. In an embodiment, the primary battery module may be used to store energy from the mains during periods when the machine is not in use or when the required power for machine operation is less than the available power from the mains. The module may contain the necessary support functions for the battery, including charging, life monitoring, temperature, and capacity. All parameters related to charger and battery status may be available via communication lines to the control processor. A processor local to the primary battery module may be used for all internal control functions and be reprogrammable from the external control processor. The primary battery module firmware may be modified through the remote communications port via the control processor. In embodiments, the battery may include a fuel cell or other device for storing energy and providing electrical power.

Secondary battery module 103 with charger and comms (or N+1 battery modules with charger and communication). In an embodiment, secondary battery modules 103 with comms may be used to store energy from the mains during periods when the machine is not in use or when the required power for machine operation is less than the available power from the mains. Secondary battery modules may be used to augment the primary battery module and back up the primary battery in the event of a fault or during maintenance. The modularity may add energy storage capacity to a machine depending on the application and duty cycle. Each module may contain the necessary support functions for the battery, including charging, life monitoring, temperature, and capacity, with parameters related to charger and battery status being available via communication lines to the control processor. A processor local to the primary battery module may be used for all internal control functions and be reprogrammable from the external control processor. The secondary battery module firmware may be modified through the remote communications port via the control processor.

DC to AC (inverter) 302 with comms. In an embodiment, a DC to AC inverter may change the main's (e.g., when source 100 is DC) and/or battery module's output from DC to AC. The control processor controls the frequency and output voltage based on the machine's application and architecture. Applications where different frequencies are required, such as aircraft, are envisioned where 400 Hz might be used. “Normalized” machine architectures could be produced where no matter what the mains supply frequency and voltage are, the internal power requirements of the machine would always be the same in the same. Having one voltage and frequency in the machine's power distribution architecture would lower production costs and the requirement of spare parts for world markets. All parameters related to inverter status are available via communication lines to the control processor. A processor local to the inverter would be used for all internal control functions and be reprogrammable from the external control processor. The inverter firmware would be modified through the remote communications port via the control processor.

AC distribution panel 306 with comms. In an embodiment, an AC distribution panel may be used to route power and protect branch circuits. It may include circuit protection devices and switching devices for directing energy to other machine elements under the direction of the control processor. A processor local to the AC distribution panel may be used for all internal control functions and be reprogrammable from the external control processor. The AC distribution panel firmware would be modified through the remote communications port via the control processor.

Controller 107. Generally, controller 107 is a computing device providing with instructions, which when executed may manage the power and maintenance of the power system and, in addition, the machine being powered. Thus, in embodiments, a control processor of controller 107 may perform supervisory functions for the machine. The hardware may be implemented using a microcontroller, an FPGA, or ASIC. The operating system for this processor may be an industry-standard such as Linux or designed as a specific operating system for the application incorporating heuristic or AI algorithms to optimize the operation of the machine. In applications where the complexity of the AI function may be beyond the capabilities of controller 107, the algorithmic tasks may be off-loaded to an external computer or cloud. The control processor may be remotely commanded from external computers, servers, or the cloud, through the External Interface to reconfigure the machine for different applications. Diagnostic and maintenance reports may be generated by the control processor and sent as notifications to service personnel and businesses to take statistical data on machine operation and use. Environmental monitoring may also be recorded and compared with machine protection limits to shut down the unit for protection from overstress.

In an embodiment, controller 107 may use data supplied through comms network 113 as follows. At first power on, PFC 101 starts, supplies power to the Housekeeping DC to DC 104, which allows controller 107 and external interface 108 to start. Controller 107 then asks external interface 108 to check with an external data source (Cloud, private server, Internet, LAN) through via external network interface 108 and network 118 for information on any firmware updates for the system and gets data on utility costs to determine the most economic charge rates of the batteries 102, 103 based on the historic usage of the machine. The data on past history of system usage maybe stored within the machine or at an external site. Controller 107 may then, if required, update any firmware necessary in the system. Controller 107 then queries the PFC 101 which transfers the data on available input power based on the mains voltage at the AC source 100 and/or the output impedance of the source 100. Controller 107 then asks the batteries 102, 103 as to their charge level. Controller 107 then determines the charging requirements based on batteries 102, 103 charge state, utility costs, ambient temperature, and system usage. Controller 107 may then perform a system diagnostic by asking for pertinent data from all elements within the system. Data sets from each system element could contain power consumption, critical operating temperatures, hours of operation, last maintenance date, refrigerant pressures, motor speed, etc. Once controller 107 has completed its startup routine as described above the machine may enter its normal operation. During normal operation controller 107 may manage the power needed in each system element to optimize the cost of operating the system. For example, heater 111 may be controlled to a temperature/time profile based on the information, e.g., from display 110, as to what product was being vended, and refrigeration VFD 112 may be set based on both temperature/time and ambient temperature. Controller 107 may during normal operation report any abnormal operation through external interface 108 to via external network interface 108 and network 118 (Cloud, private server, Internet, LAN). Thus, in an embodiment, controller 107, through comms 113, may control the amount of power provided by any power source, e.g., PFC 101, primary battery module 102 with comms, secondary battery module 103 with comms, DC to AC inverter 302 with comms, PSU AC/DC 305 with comms, and AC distribution panel 306 with comms (and with AC distribution panel 306 controlled individually to any particular recipient); and may control the amount of power utilized by any element, e.g., the chargers within primary battery module 102 with comms and secondary battery module 103 with comms, DC to DC converter 104 with comms, stepper motor solenoids 106 with comms, control processor 107 with comms, external network interface 108 with comms, microwave 109 with comms, display 110 with comms, heater 111 with comms, refrigeration 112 with comms, DC to AC inverter 302 with comms, AC distribution panel 306 with comms, PSU AC/DC 305 with comms, and payment systems 320 with comms,

External network interface 108. In an embodiment, an external interface may allow communication from the control processor, allowing different forms of data such as operating instructions, firmware updates, machine inventory, time of day pricing of power, commodity pricing of goods being sold, etc. The hardware form of the external interface may be wireless, fiber, power line communication, USB, Ethernet, other forms of digital transmission, or an analog interface such as a 4 to 20 mA loop.

In embodiments, the functions of controller 107 and external network interface 108 may be bundled together in an electronic device, or distributed, as shown above and discussed further with reference to FIG. 8 and FIG. 9.

PSU AC/DC 101. In an embodiment, the PSU AC/DC power source may supply energy to low voltage motors, solenoids, conveyors to process products, and lighting and displays for product presentation. Typically, the supplied voltage may range from 12V to 48V, depending on the type of machine.

In addition to the different functions described above, which allow the control, monitoring, and implementation of the intelligent power delivery by embodiments of power system 10, the system being powered may have multiple high power loads. For example, microwave 109 may require by itself more than 1000 W.

Generally, the functions of the individual loads may be controlled and monitored by the Control processor through digital or analog communications, with the status of each of these being available via communication lines to the control processor. A control processor local to these functions may be used for all internal control and be reprogrammable from the external control processor. Local firmware may be modified through the remote communications port via the control processor.

For example, as discussed with regard to vending machine 20, many other loads may be implemented similarly. The list of loads below is not exhaustive but identifies many of the high power loads, which will benefit from the monitoring and communication described above: microwave with comms, heater with comms, refrigeration with comms, and display with comms.

FIG. 8 shows a simplified block diagram of an embodiment of a distributed computer system 800 for supporting a smart power system 10. Computer network 800 includes a number of client systems 813, 816, and 819, and a server system 822 coupled to a communication network 824 via a plurality of communication links 828. Communication network 824 provides a mechanism for allowing the various components of distributed network 800 to communicate and exchange information with each other. Client systems 813, 816, and 819 may represent any subsystems of power systems 10, 150, 160 with communications network 824 representing comms network 113. Client systems 813, 816, and 819 may represent an entire power systems 10, 150, 160 with communications network 824 representing external network 118.

Communication network 824 may itself be comprised of many interconnected computer systems and communication links. Communication links 828 may be hardwire links, optical links, satellite or other wireless communications links, wave propagation links, or any other mechanisms for communication of information. Various communication protocols may be used to facilitate communication between the various systems shown in FIG. 8. These communication protocols may include TCP/IP, HTTP protocols, wireless application protocol (WAP), vendor-specific protocols, customized protocols, and others. While in one embodiment, communication network 824 is the Internet, in other embodiments, communication network 824 may be any suitable communication network including a local area network (LAN), a wide area network (WAN), a wireless network, a intranet, a private network, a public network, a switched network, Internet telephony, IP telephony, digital voice, voice over broadband (VoBB), broadband telephony, Voice over IP (VoIP), public switched telephone network (PSTN), and combinations of these, and the like.

System 800 in FIG. 8 is merely illustrative of an embodiment and does not limit the scope of the systems and methods as recited in the claims. One of ordinary skill in the art would recognize other variations, modifications, and alternatives. For example, more than one server system 822 may be connected to communication network 824. As another example, a number of client systems 813, 816, and 819 may be coupled to communication network 824 via an access provider (not shown) or via some other server system. An instance of a server system 822 and a client system 813 may be part of the same or a different hardware system. An instance of a server system 822 may be operated by a provider different from an organization operating an embodiment of a system for specifying an object in a design, or may be operated by the same organization operating an embodiment of a system for specifying an object in a design.

Client systems 813, 816, and 819 typically request information from a server system 822 which provides the information. Server systems by definition typically have more computing and storage capacity than client systems. However, a particular computer system may act as both a client and a server depending on whether the computer system is requesting or providing information. Aspects of the system may be embodied using a client-server environment or a cloud-cloud computing environment.

Server 822 is responsible for receiving information requests from client systems 813, 816, and 819, performing processing required to satisfy the requests, and for forwarding the results corresponding to the requests back to the requesting client system. The processing required to satisfy the request may be performed by server system 822 or may alternatively be delegated to other servers connected to communication network 824.

Client systems 813, 816, and 819 permit users to access and query information or applications stored by server system 822. Some example client systems include portable electronic devices (e.g., mobile communication devices) such as the Apple iPhone®, the Apple iPad®, the Palm Pre™, or any device running the Apple iOS™, Android™ OS, Google Chrome OS, Symbian OS®, Windows Mobile® OS, Palm OS® or Palm Web OS™. In a specific embodiment, a “web browser” application executing on a client system enables users to select, access, retrieve, or query information and/or applications stored by server system 822. Examples of web browsers include the Android browser provided by Google, the Safari® browser provided by Apple, the Opera Web browser provided by Opera Software, the BlackBerry® browser provided by Research In Motion, the Internet Explorer® and Internet Explorer Mobile browsers provided by Microsoft Corporation, the Firefox® and Firefox for Mobile browsers provided by Mozilla®, and others. Client systems 813, 816, and 819 may run applications to enable users remotely operate switches according to various embodiments.

FIG. 9 shows a more detailed diagram of an example of a computing device 900 from a system supporting a smart power system 10. In an embodiment, a user interfaces with the system through a client system 900, such as shown in FIG. 9. Smart device, mobile client communication device, or portable electronic device 900 may include a display, screen, or monitor 906 and a input device 915 stored within a single housing 900. Housing 900 houses familiar computer components, some of which are not shown, such as a processor 920, memory 925, battery 930, speaker, transceiver, network interface/antenna 935, microphone, ports, jacks, connectors, camera, input/output (I/O) controller, display adapter, network interface, mass storage devices 940, and the like. Computer system 900 may include a bus or other communication mechanism for communicating information between components. Mass storage device (or devices) 940 may store a user application and system software components. Memory 925 may store information and instructions to be executed by processor 920.

Input device 915 may also include a touchscreen (e.g., resistive, surface acoustic wave, capacitive sensing, infrared, optical imaging, dispersive signal, or acoustic pulse recognition), keyboard (e.g., electronic keyboard or physical keyboard), buttons, switches, stylus, gestural interface (contact or non-contact gestures), biometric input sensors, or combinations of these.

Mass storage device 940 may include flash and other nonvolatile solid-state storage or solid-state drive (SSD), such as a flash drive, flash memory, or USB flash drive. Other examples of mass storage include mass disk drives, floppy disks, magnetic disks, optical disks, magneto-optical disks, fixed disks, hard disks, CD-ROMs, recordable CDs, DVDs, recordable DVDs (e.g., DVD-R, DVD+R, DVD-RW, DVD+RW, HD-DVD, or Blu-ray Disc), battery-backed-up volatile memory, tape storage, reader, and other similar media, and combinations of these.

System 800 may also be used with computer systems having different configurations, e.g., with additional or fewer subsystems. For example, a computer system could include more than one processor (i.e., a multiprocessor system, which may permit parallel processing of information) or a system may include a cache memory. The computer system shown in FIG. 9 is but an example of a computer system suitable for use. Other configurations of subsystems suitable for use will be readily apparent to one of ordinary skill in the art. For example, in a specific implementation, the computing device is mobile communication device such as a smartphone or tablet computer. Some specific examples of smartphones include the Droid Incredible and Google Nexus One®, provided by HTC Corporation, the iPhone® or iPad®, both provided by Apple, BlackBerry Z10 provided by BlackBerry (formerly Research In Motion), and many others. The computing device may be a laptop or a netbook. In another specific implementation, the computing device is a non-portable computing device such as a desktop computer or workstation.

A computer-implemented or computer-executable version of the program instructions useful to practice the present subject matter may be embodied using, stored on, or associated with computer-readable medium. A computer-readable medium may include any medium that participates in providing instructions to one or more processors for execution. Such a medium may take many forms including, but not limited to, nonvolatile, volatile, and transmission media. Nonvolatile media includes, for example, flash memory, or optical or magnetic disks. Volatile media includes static or dynamic memory, such as cache memory or RAM. Transmission media includes coaxial cables, copper wire, fiber optic lines, and wires arranged in a bus. Transmission media may also take the form of electromagnetic, radio frequency, acoustic, or light waves, such as those generated during radio wave and infrared data communications.

For example, a binary, machine-executable version, of the software useful to practice the present subject matter may be stored or reside in RAM or cache memory, or on mass storage device 940. The source code of this software may also be stored or reside on mass storage device 940 (e.g., flash drive, hard disk, magnetic disk, tape, or CD-ROM). As a further example, code useful for practicing the subject matter may be transmitted via wires, radio waves, or through a network such as the Internet. In another specific embodiment, a computer program product including a variety of software program code to implement features of the subject matter is provided.

Computer software products may be written in any of various suitable programming languages, such as C, C++, C#, Pascal, Fortran, Perl, Matlab (from MathWorks, www.mathworks.com), SAS, SPSS, JavaScript, CoffeeScript, Objective-C, Objective-J, Ruby, Python, Erlang, Lisp, Scala, Clojure, and Java. The computer software product may be an independent application with data input and data display modules. Alternatively, the computer software products may be classes that may be instantiated as distributed objects. The computer software products may also be component software such as Java Beans (from Oracle) or Enterprise Java Beans (EJB from Oracle).

An operating system for the system may be the Android operating system, iPhone OS (i.e., iOS), Symbian, BlackBerry OS, Palm web OS, bada, MeeGo, Maemo, Limo, or Brew OS. Other examples of operating systems include one of the Microsoft Windows family of operating systems (e.g., Windows 95, 98, Me, Windows NT, Windows 2000, Windows XP, Windows XP x64 Edition, Windows Vista, Windows 7, Windows CE, Windows Mobile, Windows Phone 7), Linux, HP-UX, UNIX, Sun OS, Solaris, Mac OS X, Alpha OS, AIX, IRIX32, or IRIX64. Other operating systems may be used.

Furthermore, the computer may be connected to a network and may interface to other computers using this network. The network may be an intranet, internet, or the Internet, among others. The network may be a wired network (e.g., using copper), telephone network, packet network, an optical network (e.g., using optical fiber), or a wireless network, or any combination of these. For example, data and other information may be passed between the computer and components (or steps) of a system useful in practicing the subject matter using a wireless network employing a protocol such as Wi-Fi (IEEE standards 802.11, 802.11a, 802.11b, 802.11e, 802.11g, 802.11i, and 802.11n, just to name a few examples). For example, signals from a computer may be transferred, at least in part, wirelessly to components or other computers.

The following paragraphs include enumerated embodiments.

Embodiment 1 includes power system comprising: a charging device configured to receive AC electrical power from an AC source; and a first battery electrically connected to the charging device, wherein a first capacity of the battery permits an electronic system being powered by the first battery to perform a first function, the function requiring more electrical power than available from the AC source.

Embodiment 2 includes the power system of embodiment 1, further comprising a communications network connected to the charging device, the first battery, the electronic system, and a controller, wherein, when the electronic system is being powered by the first battery, the controller: receives first data regarding a first amount of power available from the first battery; and based on the first data, provides instructions to the electronic system regarding a total amount of power available to the electronic system, the instructions causing the electronic system to modify a performance of a function internal to the electronic system.

Embodiment 3 includes the power system of embodiment 2, wherein modifying the performance includes performing or not performing the function.

Embodiment 4 includes the power system of embodiment 2, wherein the instructions specify a particular function internal to the electronic system to modify.

Embodiment 5a includes the power system of embodiment 2, further comprising a power factor correction device configured to receive AC electrical power from the source and electrically connected the charging device and connected to the communications network, wherein the controller: receives second data regarding a second amount of power available from the power factor correction device; and based on the first data and second data, provides the instructions to the electronic system regarding the total amount of power available to the electronic system.

Embodiment 5b includes the power system of embodiment 2, further comprising a power factor correction device configured to receive AC electrical power from the source and electrically connected the charging device and connected to the communications network, wherein the controller: receives second data regarding a second amount of power available from the power factor correction device; and based on the first data and second data, controls the amount of power allocated to at least one subsystem within the electronic system, wherein: when an input voltage from the AC source is lower than 200 VAC, a subsystem is controlled to reduce a first amount of power provided to the subsystem and increase a time period that the subsystem is active. In embodiment 5b, the at least one subsystem may include, e.g., a microwave oven and/or a conventional oven. It is envisioned that the increased time would lower the throughput (sales) of the electronic machine, e.g., the vending machine but the alternative would be total loss of sales thus improving the economics of the system.

Embodiment 6 includes the power system of embodiment 2, further comprising a DC power supply electrically connected to both the first battery and the power factor correction device, and providing DC power to the controller.

Embodiment 7 includes the power system of embodiment 2, wherein the controller: receives third data regarding a power usage of the electronic system; and based on the third data, provides instructions to the charging device, the instructions causing the charging device to modify a third amount of power provided by the charging device to charge the first battery.

Embodiment 8 includes the power system of embodiment 7, wherein: the controller receives electricity cost data based on time of usage; and the instructions causing the charging device to modify the third amount of power provided by the charging device to charge the first battery are based on the third data and the electricity cost data.

Embodiment 9 includes the power system of embodiment 7, wherein the controller: receives the first data and the third data over a period of time; determines, from an analysis of the first data and third data from the period of time, that the first capacity of the first battery does not match a power demand profile of the electronic system; and initiates, using the communications network, a notification of an operator, the notification providing a second capacity determined to match the power demand profile.

Embodiment 10 includes the power system of embodiment 2, wherein the controller regulates a start up sequence for the electronic system after a loss of power from the AC source.

Embodiment 11 includes the power system of embodiment 2, further including a DC to DC power supply receiving power from the first battery and providing power to the electronic system.

Embodiment 12 includes the power system of embodiment 2, further comprising a DC to AC converter electrically connected to the first battery, wherein the electronic system being powered by the first battery includes the electronic system being powered by AC power from the DC to AC converter.

Embodiment 13 includes the The power system of embodiment 2, wherein: the DC to AC converted is connected to the communications network; and the first data regarding the first amount of power available from the first battery includes power available from the DC to AC converter.

Embodiment 14 includes a method of providing power to an electronic system comprising: connecting a charging device configured to receive AC electrical power to an AC source; connecting a first battery to the charging device; and connecting the electronic system to the first battery, wherein a first capacity of the battery permits the electronic system to perform a first function, the function requiring more electrical power than available from the AC source.

Embodiment 15 includes the method of embodiment 14, further comprising: receiving, by a controller connected via a communications network to the charging device, first battery, and electronic system, first data regarding a first amount of power available from the first battery; and based on the first data, providing, by the controller using the communications network, instructions to the electronic system regarding a total amount of power available to the electronic system, the instructions causing the electronic system to modify a performance of a function internal to the electronic system.

Embodiment 16 includes the method of embodiment 15, wherein the instructions specify a particular function internal to the electronic system to modify.

Embodiment 17 includes the method of embodiment 15, further comprising: receiving, by the controller, second data regarding a second amount of power available from a power factor correction device providing AC power to the charging device; and based on the first data and second data, providing, by the controller, the instructions to the electronic system regarding the total amount of power available to the electronic system.

Embodiment 18 includes the method of embodiment 15, further comprising: receiving, by the controller, third data regarding a power usage of the electronic system; and based on the third data, providing, by the controller, instructions to the charging device causing the charging device to modify a third amount of power provided by the charging device to charge the first battery.

Embodiment 19 includes the method of embodiment 18, further comprising: receiving, by the controller, electricity cost data based on time of usage, wherein the instructions causing the charging device to modify the third amount of power provided by the charging device to charge the first battery are based on the third data and the electricity cost data.

Embodiment 20 includes the method of embodiment 18, wherein the controller receives the first data and the third data over a period of time, the method further comprising: determining, by the controller from an analysis of the first data and third data from the period of time, that the first capacity of the first battery does not match a power demand profile of the electronic system; and initiating, by the controller using the communications network, a notification of an operator, the notification providing a second capacity determined to match the power demand profile.

The previous description is provided to enable any person skilled in the art to practice the various aspects described herein. In the embodiments, the separation of various system components in the embodiments described above should not be understood as requiring such separation in all embodiments. Various modifications to these aspects will be readily apparent to those skilled in the art, and the generic principles defined herein may be applied to other aspects.

In describing the invention, it will be understood that a number of techniques and steps are disclosed. Each of these has individual benefit and each may also be used in conjunction with one or more, or in some cases all, of the other disclosed techniques. The specification and claims should be read with the understanding that such combinations are entirely within the scope of the invention and the claims.

In the description above and throughout, numerous specific details are set forth in order to provide a thorough understanding of an embodiment of this disclosure. It will be evident, however, to one of ordinary skill in the art, that an embodiment may be practiced without these specific details. In other instances, well-known structures and devices are shown in block diagram form to facilitate explanation. The description of the preferred embodiments is not intended to limit the scope of the claims appended hereto. Further, in the methods disclosed herein, various steps are disclosed illustrating some of the functions of an embodiment. These steps are merely examples and are not meant to be limiting in any way. Other steps and functions may be contemplated without departing from this disclosure or the scope of an embodiment.

Thus, the claims are not intended to be limited to the aspects shown herein, but are to be accorded the full scope consistent with the language claims.

As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will further be understood that the terms “comprises” and/or “comprising,” when used in this specification, specify the presence of states features, steps, operations, elements, and/or components, but do not preclude the present or addition of one or more other features, steps, operations, elements, components, and/or groups thereof.

As used herein, reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

A phrase such as an “aspect” does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa. A phrase such as a “configuration” does not imply that such configuration is essential to the subject technology or that such configuration applies to all configurations of the subject technology. A disclosure relating to a configuration may apply to all configurations, or one or more configurations. A phrase such as a configuration may refer to one or more configurations and vice versa.

Unless otherwise defined, all terms (including technical and scientific terms) used herein have the same meaning as commonly understood by one having ordinary skill in the art to which this invention belongs. It will further be understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

All structural and functional equivalents to the elements of the various aspects described throughout this disclosure that are known or later come to be known to those of ordinary skill in the art are expressly incorporated herein by reference and are intended to be encompassed by the claims.

We claim:

1. A power system comprising:
a charging device configured to receive AC electrical power from an AC source; and
a first battery electrically connected to the charging device, wherein a first capacity of the first battery permits an electronic system being powered by the first battery to perform a first function, the function requiring more electrical power than available from the AC source.

2. The power system of claim 1, further comprising a communications network connected to the charging device, the first battery, the electronic system, and a controller, wherein, when the electronic system is being powered by the first battery, the controller:
receives first data regarding a first amount of power available from the first battery; and
based on the first data, provides instructions to the electronic system regarding a total amount of power available to the electronic system, the instructions causing the electronic system to modify a performance of a function internal to the electronic system.

3. The power system of claim 2, wherein modifying the performance includes performing or not performing the function.

4. The power system of claim 2, wherein the instructions specify a particular function internal to the electronic system to modify.

5. The power system of claim 2, further comprising a power factor correction device configured to receive AC electrical power from the source and electrically connected the charging device and connected to the communications network, wherein the controller:
receives second data regarding a second amount of power available from the power factor correction device; and
based on the first data and second data, controls the amount of power allocated to at least one subsystem within the electronic system, wherein:
when an input voltage from the AC source is lower than 200 VAC, the subsystem is controlled to reduce a first amount of power provided to the subsystem and increase a time period that the subsystem is active.

6. The power system of claim 2, further comprising a DC power supply electrically connected to both the first battery and the power factor correction device, and providing DC power to the controller.

7. The power system of claim 2, wherein the controller:
receives third data regarding a power usage of the electronic system; and
based on the third data, provides instructions to the charging device, the instructions causing the charging device to modify a third amount of power provided by the charging device to charge the first battery.

8. The power system of claim 7, wherein:
the controller receives electricity cost data based on time of usage; and
the instructions causing the charging device to modify the third amount of power provided by the charging device to charge the first battery are based on the third data and the electricity cost data.

9. The power system of claim 7, wherein the controller:
receives the first data and the third data over a period of time;
determines, from an analysis of the first data and third data from the period of time, that the first capacity of the first battery does not match a power demand profile of the electronic system; and
initiates, using the communications network, a notification of an operator, the notification providing a second capacity determined to match the power demand profile, the second capacity representing a second battery to be added to the power system or to replace the first battery.

10. The power system of claim 2, wherein the controller regulates a start up sequence for the electronic system after a loss of power from the AC source.

11. The power system of claim 2, further including a DC to DC power supply receiving power from the first battery and providing power to the electronic system.

12. The power system of claim 2, further comprising a DC to AC converter electrically connected to the first battery, wherein the electronic system being powered by the first battery includes the electronic system being powered by AC power from the DC to AC converter.

13. The power system of claim 2, wherein:
the DC to AC converted is connected to the communications network; and
the first data regarding the first amount of power available from the first battery includes power available from the DC to AC converter.

14. A method of providing power to an electronic system comprising:
connecting a charging device configured to receive AC electrical power to an AC source;
connecting a first battery to the charging device; and
connecting the electronic system to the first battery, wherein a first capacity of the battery permits the electronic system to perform a first function, the function requiring more electrical power than available from the AC source.

15. The method of claim 14, further comprising:
receiving, by a controller connected via a communications network to the charging device, first battery, and electronic system, first data regarding a first amount of power available from the first battery; and
based on the first data, providing, by the controller using the communications network, instructions to the electronic system regarding a total amount of power available to the electronic system, the instructions causing the electronic system to modify a performance of a function internal to the electronic system.

16. The method of claim 15, wherein the instructions specify a particular function internal to the electronic system to modify.

17. The method of claim 15, further comprising:
receiving, by the controller, second data regarding a second amount of power available from a power factor correction device providing AC power to the charging device; and
based on the first data and second data, providing, by the controller, the instructions to the electronic system regarding the total amount of power available to the electronic system.

18. The method of claim 15, further comprising:
receiving, by the controller, third data regarding a power usage of the electronic system; and
based on the third data, providing, by the controller, instructions to the charging device causing the charging device to modify a third amount of power provided by the charging device to charge the first battery.

19. The method of claim 18, further comprising:
receiving, by the controller, electricity cost data based on time of usage, wherein the instructions causing the charging device to modify the third amount of power provided by the charging device to charge the first battery are based on the third data and the electricity cost data.

20. The method of claim 18, wherein the controller receives the first data and the third data over a period of time, the method further comprising:
determining, by the controller from an analysis of the first data and third data from the period of time, that the first capacity of the first battery does not match a power demand profile of the electronic system; and
initiating, by the controller using the communications network, a notification of an operator, the notification providing a second capacity determined to match the power demand profile.
